(19) United States
(12) Patent Application Publication
(10) Pub. No.: US 2007/0113281 A1
(43) Pub. Date: May 17, 2007

(54) Method used in the control of a physical system affected by threats

(76) Inventor: John Leach, Hants (GB)

Correspondence Address: SYNNESTVEDT LECHNER & WOODBRIDGE LLP, P O BOX 592, 112 NASSAU STREET, PRINCETON, NJ, 08542-0592, US

(21) Appl. No.: 10/577,507

(22) PCT Filed: Nov. 1, 2004
(86) PCT No.: PCT/GB04/04619

§ 371 Date: Apr. 27, 2006

(30) Foreign Application Priority Data
Oct. 31, 2003 (GB) 0325504.9

(51) Int. Cl. G06F 12/14

(52) U.S. Cl. 726/22

(57) ABSTRACT

The method involves (a) modelling how an entity generates another entity to form a risk chain, the risk chain being a series of two or more entities that each model a discrete part of how a threat leads to damage to the system, each entity being described as a population of elements distributed in a parameter or parameters; and (b) controlling the physical system by using results of the modelling. Implementations provide a method for calculating the likelihood and characteristics of security breaches as a function of the measured security threats and the countermeasures deployed.

### FIELD OF THE INVENTION

This invention relates to a method used in the control of a physical system affected by threats and hence falls within the field of Security Risk Management, including but not limited to information security risk management. The present invention can be applied to any security threats, including but not limited to:
Information security threats such as viruses and worms; Computer crime such as financial fraud committed by or via computer;
Conventional (non-IT oriented) crime such as benefit fraud, burglary, activist disruption or organised crime;
Terrorism and malicious attacks against the state, persons or property;
Non-malicious but intentional attacks such as hacking (as opposed to cracking);
Unintentional attacks such as staff security carelessness and hazards;

It can be applied most immediately to threats where the level of threat activity is both continual and can be measured readily. It can also be applied to threats where threat activity levels are more rare than continual, and, in combination with data management approaches such as extreme value theory, to threats which are very intermittent

### BACKGROUND OF THE INVENTION

Security risk advisors and practitioners (collectively “practitioners”) are expected to advise stakeholders and senior management on the risks an organisation faces from the prevailing security threats such as theft of merchandise or product, viruses, intrusion attacks, misuse of corporate IT facilities, insider fraud, assault on premises, etc. There has in the past been no scientific framework available to practitioners which would have enabled them to determine in objective numerical form the magnitude or nature of the risks an organisation faced given an objective quantification of the threats the organisation was under and the security measures which had been taken. Consequently, much security risk management advice has perforce been based on the experience, common sense and subjective expertise of the practitioner in question. Stakeholders and senior management frequently request more objective decision-making support from their practitioners, requests articulated in terms of asking for the “Return on Investment” of a proposed security expenditure or asking for an objective financial measure of the benefit of proposed or deployed security measures. Practitioners' inability to produce such objective figures prevents management having a reliable and accurate assessment of their present security risks, of how those risks are changing from month to month, and of the expected effects and benefits of the security efforts or expenditures they might make.

### SUMMARY OF THE INVENTION

In a first aspect, a method used in the control of a physical system, comprises the steps of
(A) modelling a risk chain, the risk chain being a series of two or more entities that each model a discrete part of how a threat leads to damage to a target system, each entity being described as a population of elements distributed in a parameter or parameters, each entity generating the next entity in the chain; and
(b) controlling the physical system by using results of the modelling.

The way one entity in the risk chain generates another entity in the risk chain may be described by a quantitative generation function. Modelling countermeasures to one or more entities in the risk chain is also possible; each countermeasure may then be quantitatively described as a function of one or more variables. A countermeasure may then be deployed to an entity in such a manner so that the effect of the entity is diminished to a definable, quantitative level; the level may have been pre-defined.

The or each variable describing a countermeasure determines the efficacy of that countermeasure in modifying the population of elements in an entity or influencing how one entity in the risk chain generates a related entity in the risk chain. The deployment of countermeasures may then be quantitatively optimised.

The distribution of elements of an entity in a parameter may be a measured distribution; this may be a real-time measured distribution. The measured distribution can also be compared to: a predicted distribution, the comparison enabling the accuracy of an algorithm used to make the prediction to be improved.

The controlled system may be controlled by being dynamically altered on the basis of the modelling; this may occur based on measurements of the distribution of elements in one or more parameters.

Each entity in the risk chain may be an entity with substantially the properties of an entity selected from the following list of entity types: threat agents; attacks; security breaches; disruptions; damage.

The target system can be any of, for example, a computer; a group of computers, a computer network; a telecommunication system; a mobile communications device or personal digital assistant; a building, group of buildings, physical infrastructure, means of transport or a transport infrastructure, aircraft or vehicle; a physical storage container; a business, business process or business system.

Further, an entity in the risk chain can describe a population of one or more people who seek or otherwise obtain unauthorised access to the target system or who seek to or otherwise influence the target system in an unauthorised manner. An entity of the risk chain can also describe a population of one or more computer viruses or worms or Trojan Horses or computers. Then, a parameter may be the age of the virus.

An entity of the risk chain can for example also describe a population of one or more fires, floods, earthquakes or other physical acts which have an impact on the target system.

In another aspect, there is a method of modelling a specific security threat to a system, comprising the step of modelling a risk chain, the risk chain being a series of two or more entities that each model a discrete part of how a threat leads to damage to the system, each entity being described as a population of elements distributed in a parameter or parameters, each entity generating the next entity in the chain.

In a third aspect, there is a computer network controlled using the method used in the control of a physical system defined above.

In a fourth aspect, there is a computer network designed using the method of modelling defined above.

In a fifth aspect, there is a physical system controlled using the method used in the control of a physical system defined above, in which the physical system is a system selected from the following list: a telecommunication system; a mobile communications device or personal digital assistant; a building, group of buildings, physical infrastructure, means of transport, transport infrastructure, aircraft or vehicle; a physical storage container.

In a sixth aspect, there is a physical system designed using the method of modelling defined above, in which the physical system is a system selected from the following list: a telecommunication system; a mobile communications device or personal digital assistant; a building, group of buildings, physical infrastructure, means of transport, transport infrastructure, aircraft or vehicle; a physical storage container.

A seventh aspect is a method of insuring against risk or underwriting risk using the method of modelling defined above.

An eight aspect is a method of pricing insurance risk using the method of modelling defined above. The risk can be ‘digital risk’—i.e. the risk associated with digital attacks such as viruses, worms, Trojan horses etc.

A ninth aspect is a countermeasure when calibrated with a quantitative measure of efficacy using the method of modelling defined above, in which the quantitative measure is the efficacy of that countermeasure in modifying the population of elements in an entity or influencing how one entity in the risk chain generates another entity in the risk chain.

A tenth aspect is a method of calibrating a countermeasure with a quantitative measure of efficacy using the method of modelling defined above, in which the quantitative measure is the efficacy of that countermeasure in modifying the population of elements in an entity or influencing how one entity in the risk chain generates another entity in the risk chain.

A final aspect is a method of representing a threat comprising the steps of

(a) modelling that threat using the method of modelling defined above;

(b) sending information representing the modelled threat over a wide area network;

(c) displaying that information on a computer connected to the network.

### BRIEF DESCRIPTION OF THE DRAWINGS

The present invention will be described with reference to the accompanying drawings in which:

FIG. 1 schematically depicts the Risk Chain—a figurative portrayal of the model (countermeasures not shown) showing the dynamics from threat agents through to the damage the agents' attacks cause.

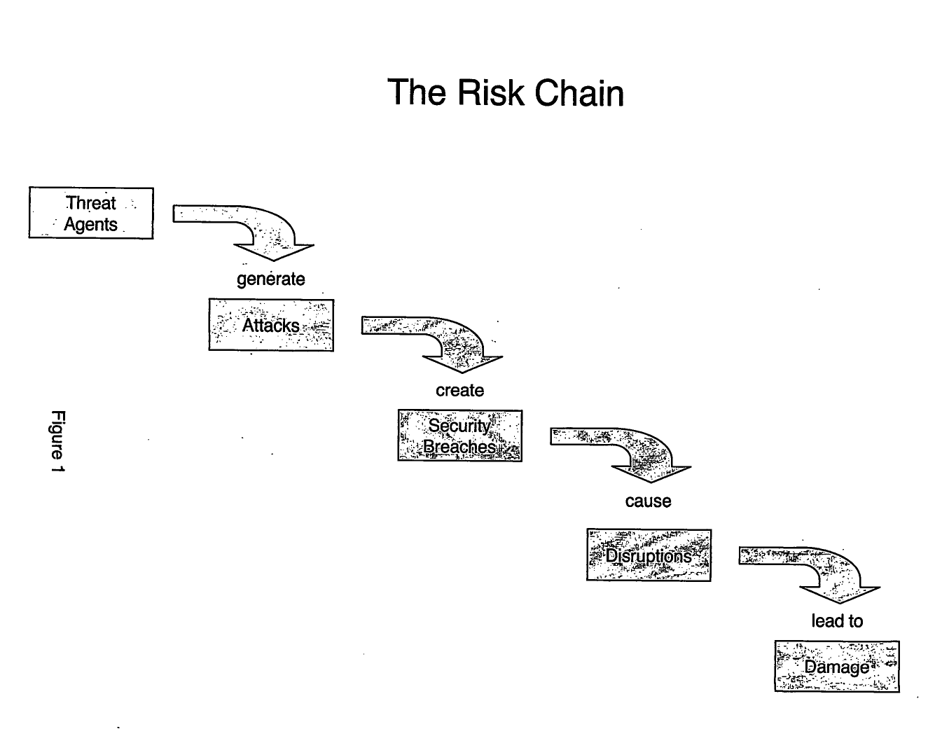

FIG. 2 shows the Risk Chain with countermeasures included—showing where within the Risk Chain the different classes of countermeasure apply.

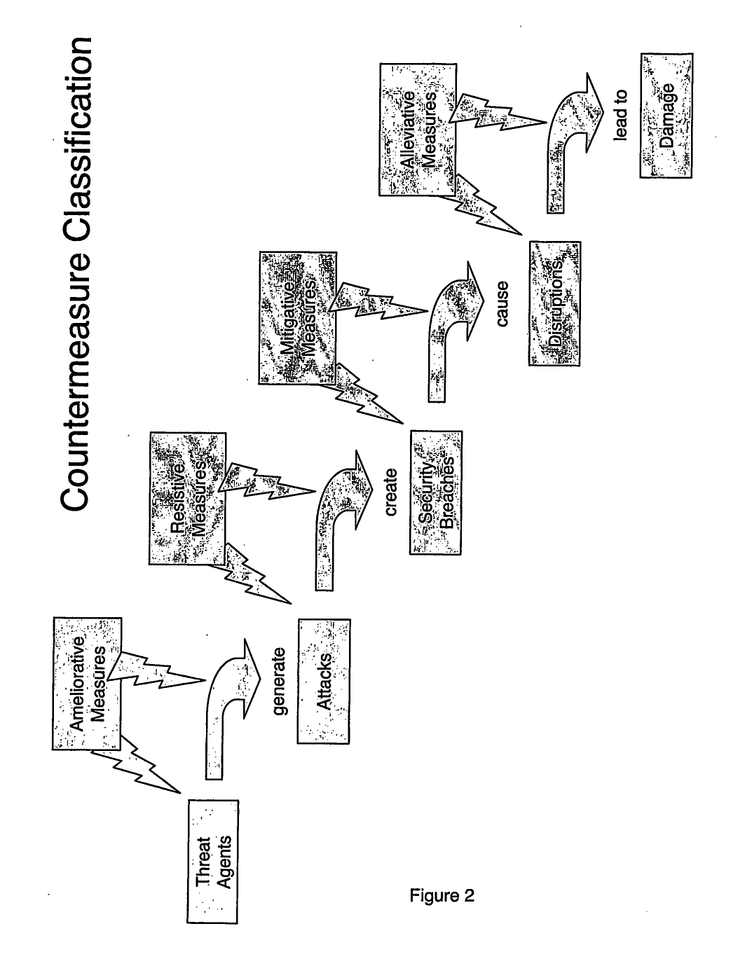

FIG. 3 is a schematic representation of a target existing simultaneously within two overlapping threat environments.

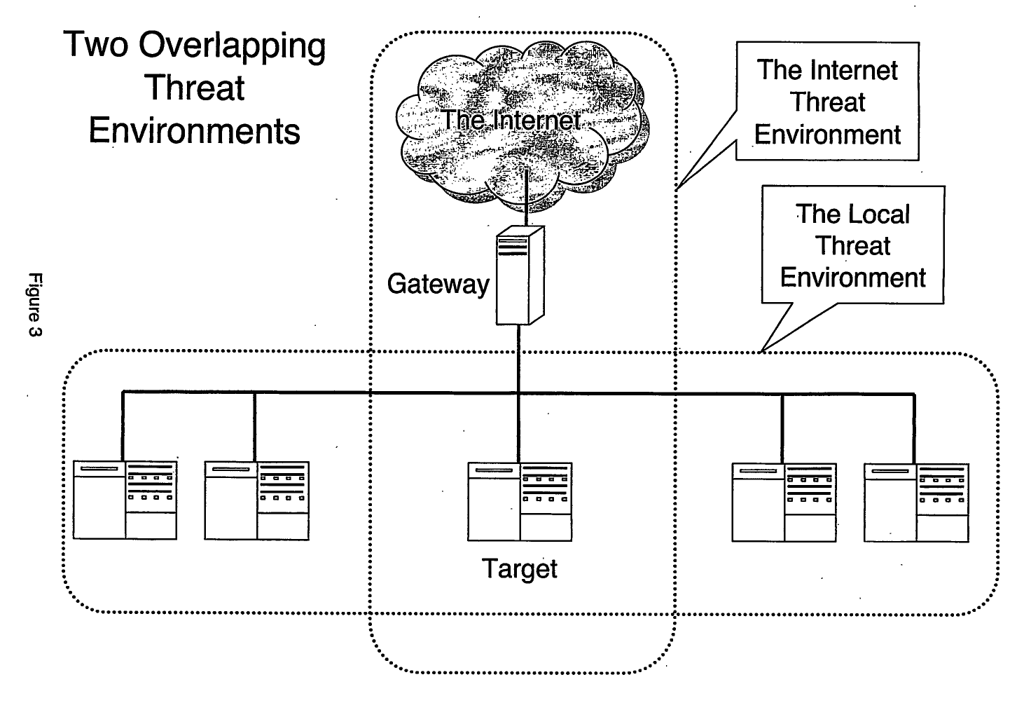

FIG. 4 is an example threat profile for the e-mail virus threat.

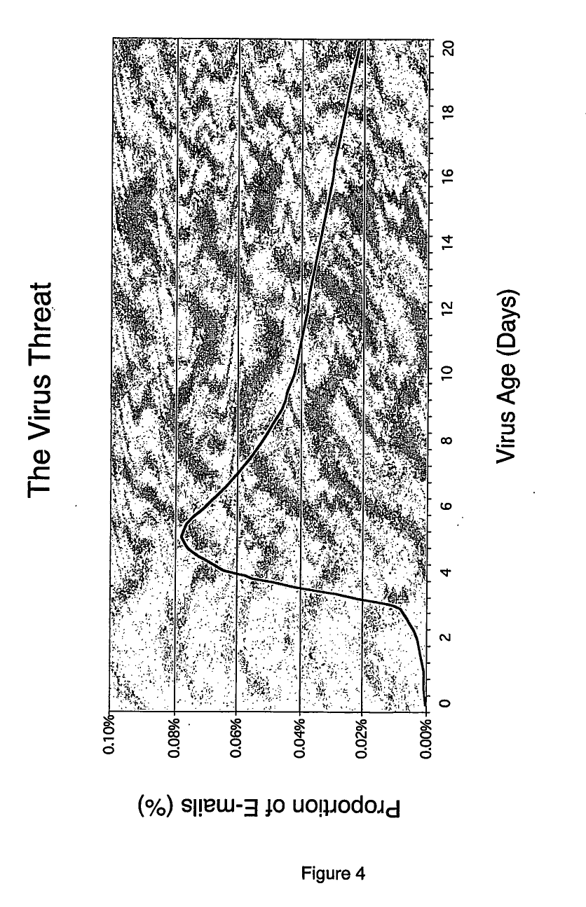

FIG. 5 is an example threat profile for worms exploiting the Microsoft LSASS vulnerability (BID 10108).

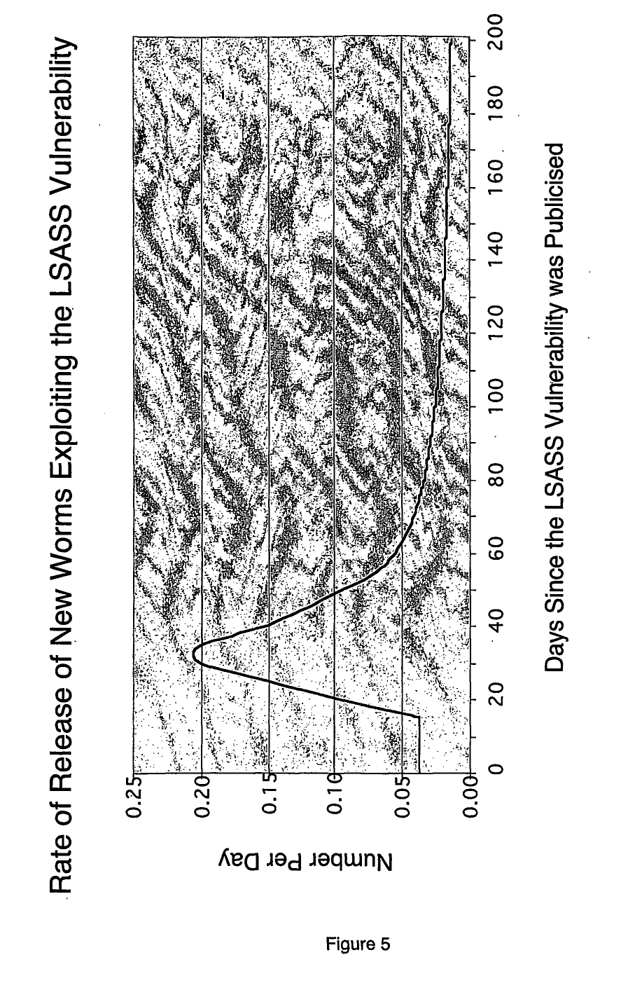

FIG. 6 is a schematic representation of the scenario being modelled in Example 1.

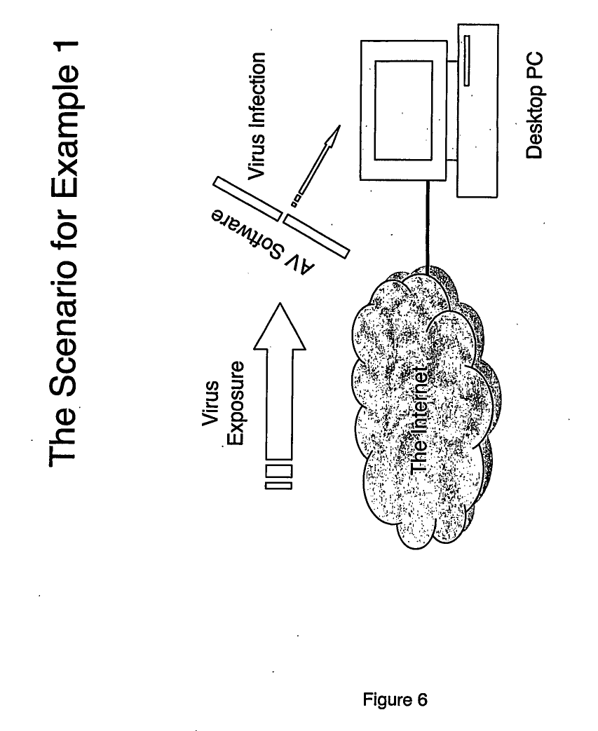

FIG. 7 depicts the resistance function for Example 1.

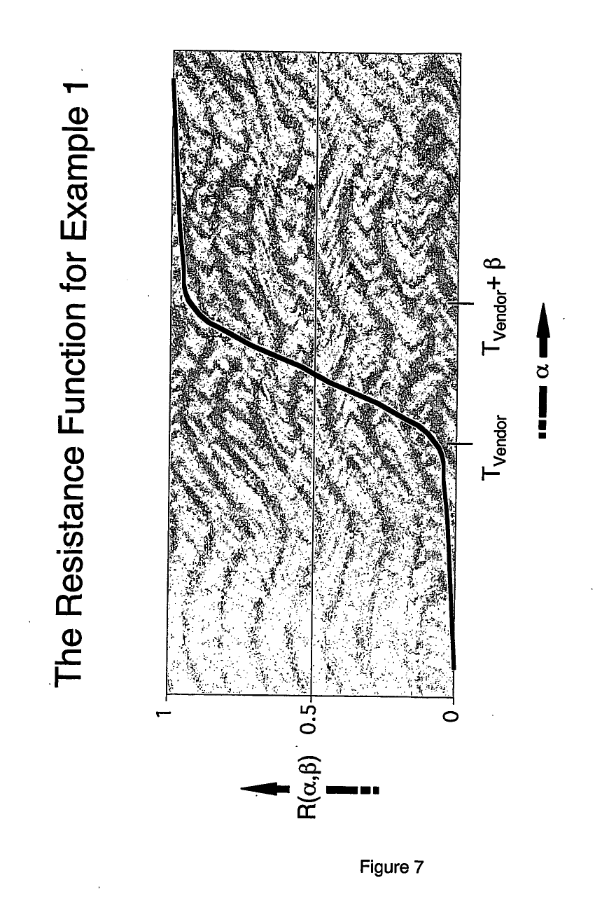

FIG. 8 depicts the parent risk entity profile for Example 1.

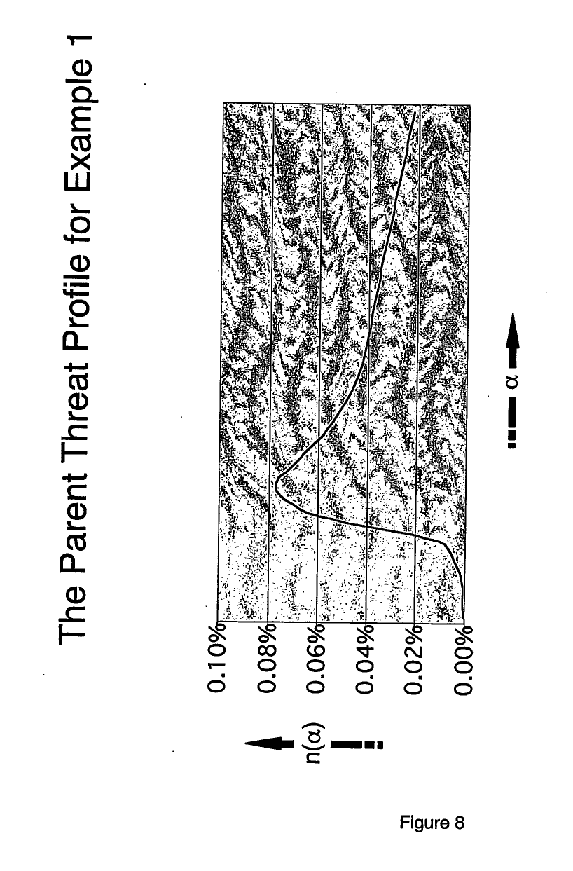

FIG. 9 depicts the risk result for Example 1.

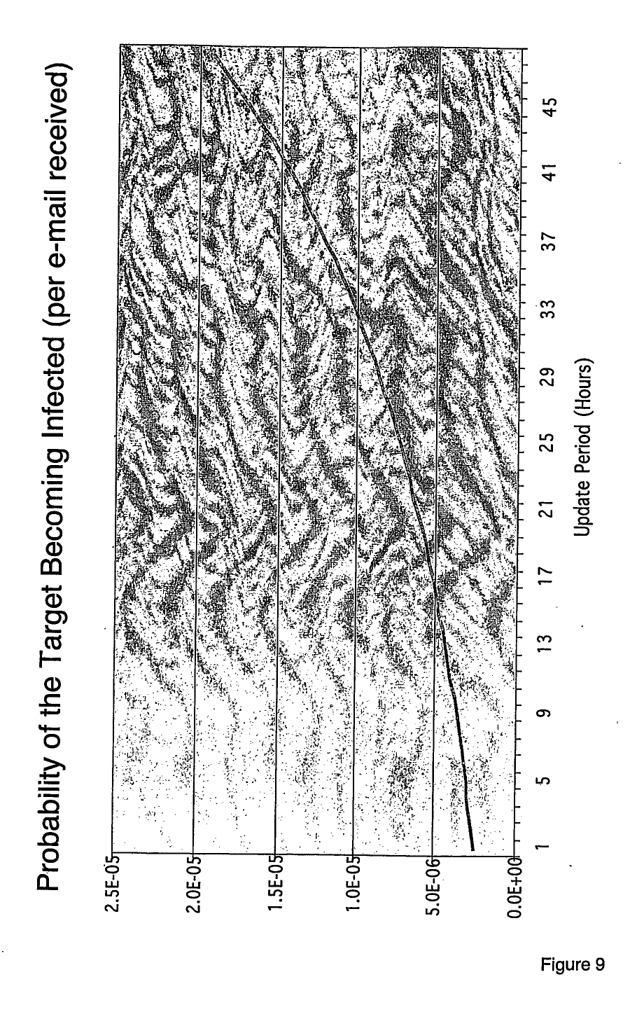

FIG. 10 depicts a second risk result for Example 1.

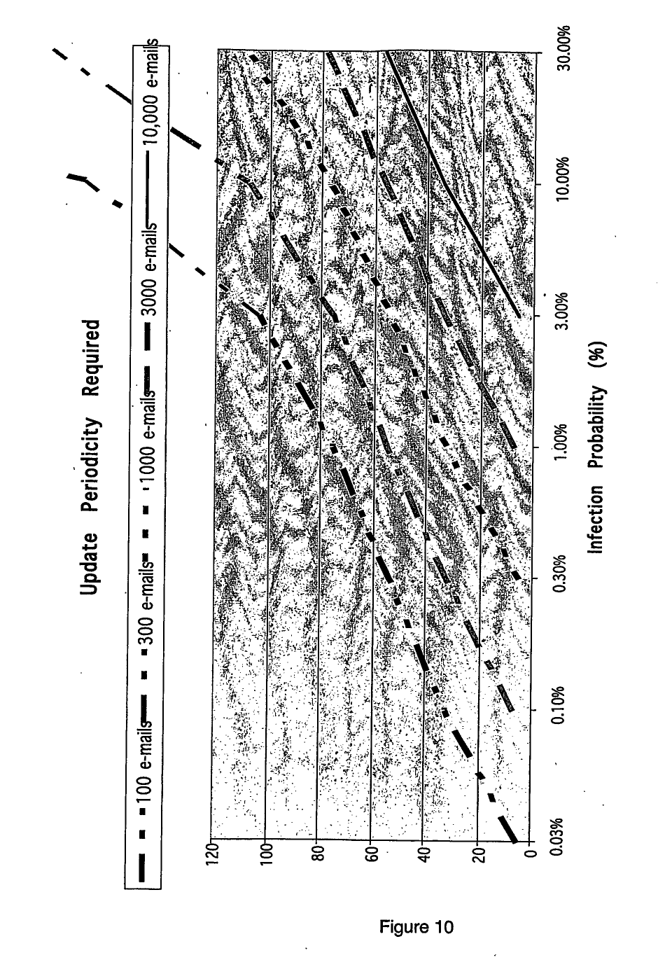

FIG. 11 is the generation function for Example 2.

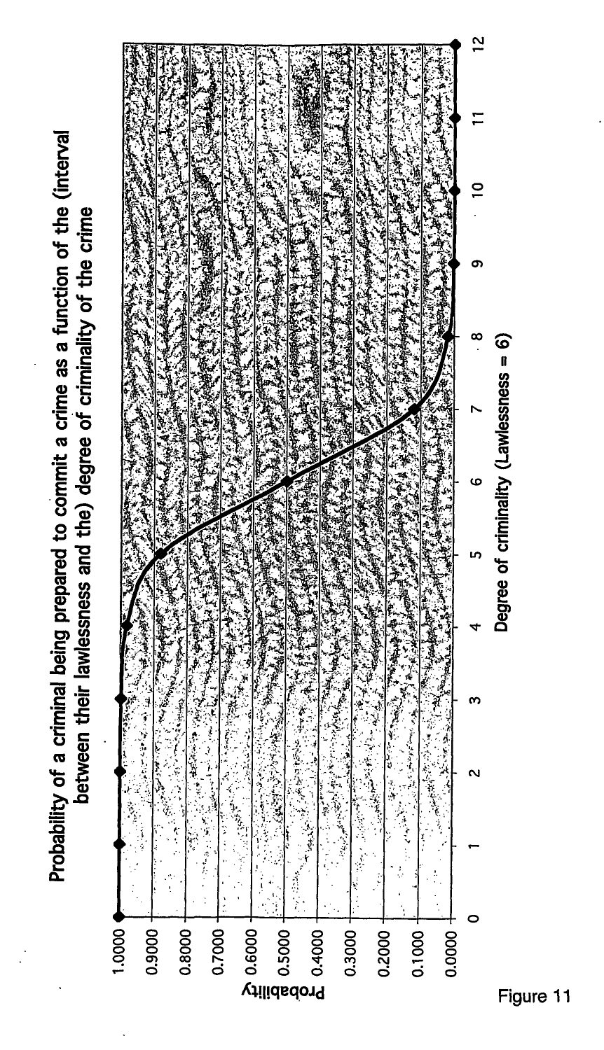

FIG. 12 is the function describing the effectiveness of security vetting for Example 2.

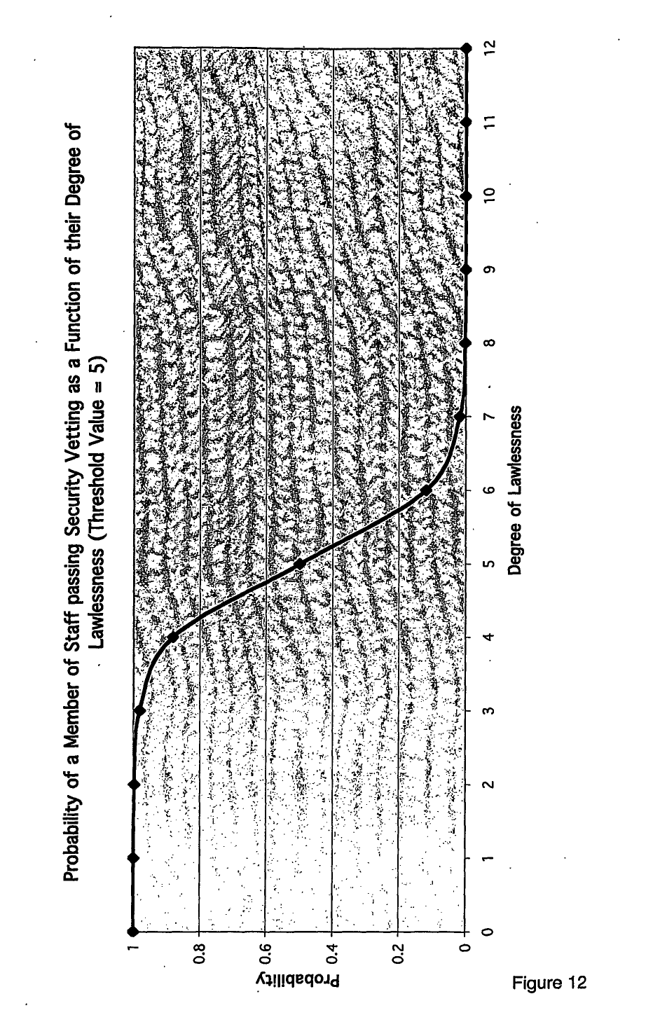

FIG. 13 is the parent risk entity profile for Example 2.

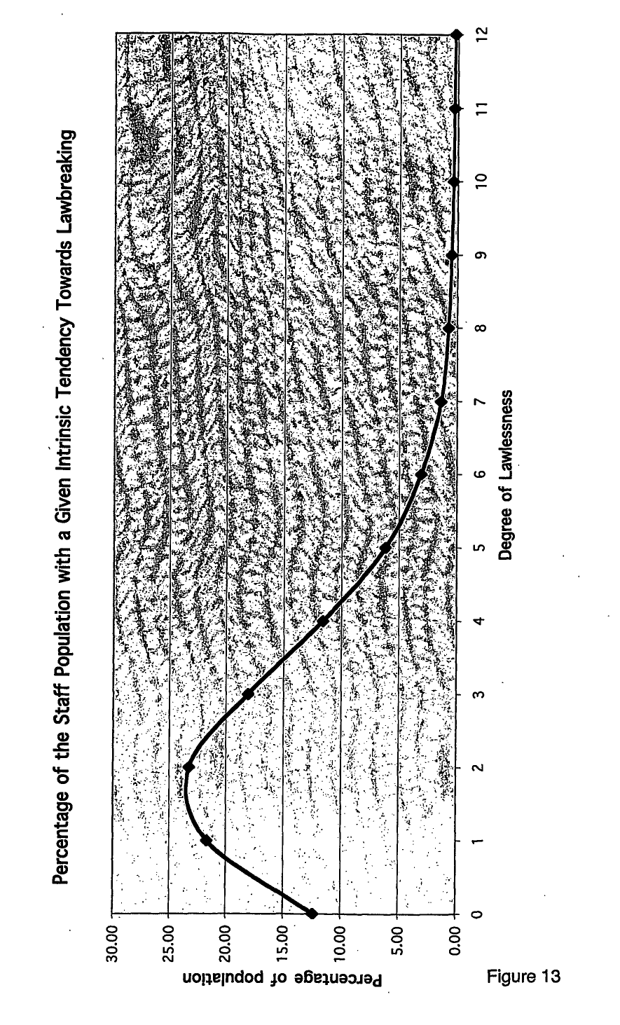

### DETAILED DESCRIPTION

The present invention is implemented in a system and process called Threat-Based Security Engineering (“TBSE”). TBSE is a method for calculating the likelihood and characteristics of security breaches as a function of the measured security threats and the countermeasures deployed.

TBSE describes a methodology for modelling and forecasting the expected probability, severity and impact of specific security breaches as a function of the measured threat profile and of parameterised descriptions of the countermeasures deployed. The methodology models the interactions between threats and countermeasures and shows how to determine the rate and characteristics of the specific security breaches which result. It shows how to measure and profile threats in a manner which exposes the ability of the threat to engender risk. It shows how to model and describe countermeasures according to their effectiveness at achieving their intended purposes against the threats. It shows how to calculate from these inputs and analytical descriptions the likelihood of specific security breaches and the severity and impact the breaches can be expected to cause for any target under threat. This invention provides the necessary basis for quantitative risk management including designing accurate and reliable security measures, optimising security plans, evaluating the benefits of countermeasure deployments, and providing “Return on Investment” figures. It can be expected to spawn a number of new security products and services, and to underpin the creation of an active Digital Risks insurance market.

TBSE describes a method for modelling the interactions which occur between threats and security countermeasures and which result in security breaches, system or process disruptions and associated financial, reputational, operational or other damage.

It provides a model (refer to Drawing 1), based on what is here called a risk chain, which enables a practitioner to describe and calculate how threat agents generate attacks, how attacks create security breaches, how security breaches cause disruptions, and how disruptions lead to damage.

The model allows practitioners to introduce countermeasures which can influence particular processes within the risk chain (refer to Drawing 2), enabling the practitioner to describe and then calculate the effects of the countermeasure(s) on the magnitude and characteristics of other entities within the chain, for example the rate of occurrence of specific security breaches, or on indices such as specified risk indices.

The risk chain comprises a sequence of five risk entities. Each risk entity is the child of the preceding risk entity and the parent of the subsequent risk entity. Each risk entity is modelled as a population of elements and is described by a profile, where the profile gives the distribution of elements within the population according to one or more parameters. The way in which elements of a parent entity generate elements of the child entity is described by generating functions and influenced by countermeasures. In this way, the expected profile of child elements can be calculated from the profile of parent elements as a function of the parameters which describe relevant generators and countermeasures. The profile of the parent elements can be either measured, postulated or themselves calculated from their parents and the relevant generating functions and countermeasures.

TBSE categories countermeasures into four classes according to where within the risk chain they achieve their effect (refer to Drawing 2). The first two classes of countermeasure together affect the likelihood of the resultant security breaches, the first three together affect the expected magnitude and distribution of disruption severity and all four together affect the expected magnitude and distribution of resultant impact.

TBSE describes the process of creating an analytical description of any countermeasure in terms of the manner by which the countermeasure influences the dynamics of the risk chain, and it shows how to parameterise the description in preparation for modelling. It describes how to profile risk entities (e.g. threats), in a way suitable for modelling their interactions with countermeasures and generators, so, that the risk entity profiles can be measured and quantified.

It shows how to calculate from risk entity profiles and parameterised generation function and countermeasure descriptions the profile of subsequent risk entities in the chain, for example how to calculate from the attack profile the likelihood that the modelled countermeasure(s) will fail to prevent the attacks contained within the threat from being successful. Successful attacks create the security breaches being forecast. It enables the practitioner to calculate how the likelihood of attacks being successful will vary as a function of the way relevant countermeasures are deployed. It also enables the practitioner to calculate, based on the measured threats (attack profile), how the likelihood of attacks being successful will vary as a function of the way the measured threat varies over time, and how the severity and impact of successful attacks will vary as a function of the way relevant countermeasures are deployed.

The skill in using the invention lies primarily in the skill with which the practitioner identifies the relevant parameters and functions for the modelling.

Using TBSE

To use TBSE, the following steps are carried out:
1. For each threat of interest, specify the relevant risk entities and identify and classify the relevant countermeasure(s) of interest.
2. For each generator of interest, determine which parameter(s) have a significant influence on the rate at which elements of the parent risk entity generate elements of the child risk entity and on the characteristics of the child elements generated. Then develop the generation functions which describe each of those generators.
3. For each countermeasure of interest, determine which parameter(s) have a significant influence on the effectiveness of the countermeasure at achieving its intended purpose. Then develop the functions which describe each of those countermeasures.
4. Determine the variable(s) with which to profile each risk entity of interest.
5. Develop the functions which describe each child risk entity of interest in terms of preceding risk entities, generators and countermeasures.
6. Measure and profile the relevant parent risk entity(entities).
7. Use the measured profile of the parent risk entity to calculate the expected profile of each subsequent child risk entity of interest, each as a function of the parameters used to describe the generation function(s) and countermeasure(s) previously identified.
8. If appropriate, measure the profile of relevant child risk entities and compare the measured profiles with the expected profiles calculated.
9. From the profile of each child risk entity, form the risk indices or other moments of interest. Calculate how these indices or moments vary as a direct function of the measured input risk entities (e.g. the threat) and the generator and/or countermeasure parameters.
   Definitions
Attack—an action or sequence of actions, whether accidental or wilful, malicious or non-malicious, attempted against the target. It includes unsuccessful attacks as well as successful attacks.
Child risk entity—the risk entity generated by the parent risk entity within a stage of the risk chain.
Countermeasure—a measure (e.g. deployed security product, practice or arrangement) implemented with the objective of helping to protect the target, i.e. countering the threat and influencing (usually to reduce the probability of or severity of) the security breaches, disruptions and damage which result
Disruption—the resultant impairment of a key attribute of a component, process or system within the target under attack as caused by the security breach bearing upon the target. The form of the disruption will depend on the form of the attack and the nature of the affect a successful attack has on the target. It could, for example, appear in the form of:
   The cessation of a process caused by a Denial of Service attack or theft or destruction of a critical resource;
   An impairment of a process caused by the disclosure of sensitive information or the corruption of critical information;
   The misapplication of a key process as in a fraud;
   The destruction of property by a flood.
Generator—the process by which elements of a parent risk entity generate elements of the relevant child risk entity.
Generation function—a function which describes a generator, i.e. the function which describes the dynamics by which elements of a parent risk entity generate elements of the relevant child risk entity. A generation function might describe the inherent dynamics by which the parent elements generate child elements or might include the effects of steps taken by any relevant party which, intentionally or otherwise, enhance or modify the generation of child elements or of the risk engendered.
Impact—the amount of damage (usually measured in terms of financial losses, costs, loss of property or life) caused by a disruption.
Parent risk entity—the progenitor of the child risk entity within a stage of the risk chain.
Practitioner—the person using the invention, usually a risk manager or security expert.
Risk—any of several indices each a characteristic measure, moment or indicator of the profile of a risk entity. For example:
   the aggregate likelihood of a specific security breach occurring,
   the weighted average severity of the disruptions caused by specific security breaches,
   the expected impact of the damage resulting from specific security breaches.
Risk Chain—the collected risk entities, generators and countermeasures which interact to engender risk, considered in the form of a sequence of dynamics between risk entities with countermeasures influencing the dynamics at each stage in the sequence (refer to Drawing 1). Each stage in the sequence comprises a parent risk entity, a child risk entity, the generator(s) which embody the dynamics by which the parent generates the child, and the countermeasures which influence the parent risk entity or those dynamics.
Risk Entities—the entities comprising the backbone of the risk chain, namely:
   Threat agents
   Attacks
   Security breaches
   Disruptions
   Damage

Each risk entity is the parent of the risk entity which follows it in the chain, and is the child of the risk entity which precedes it in the chain.
Security Breach—the breach which results from the action of security attacks which are successful upon the target A security breach could take any of a wide variety of forms. For example, a security breach could be illegitimate consumption of processing resources (perhaps as the result of Denial of Service attacks), unauthorized intrusion into the system (perhaps as the result of hacking attacks), unapproved use of resources (perhaps as the result of staff misuse of corporate Internet access), free use of system facilities (perhaps as the result of staff abuse of privileges), breach of a flood defense.
Severity—the intrinsic magnitude of the disruption arising as a consequence of a security breach. For example, the duration of a system outage, the proportion of the misappropriated funds which are not recoverable.
Target—the system under threat.
Threat—the state of having security attacks raining down on the target.
Threat agent—the agents (including human agents, autonomous computerised agents, and serendipity) which are the source or generators of security attacks.
Threat environment—the environment containing the threat agents, attacks, countermeasures and target. A target might exist simultaneously within more than one threat environment (see Drawing 3), for example the Internet threat environment could include Internet-originated viruses along with the target and relevant countermeasures, and the local threat environment could include viruses originating from locally networked computers along with the target and the relevant countermeasures.
Threat profile (usually shown in the form of a chart)—the rate of attacks as a function of one or more variables.
   Process

The following processes are applied to each threat of interest to the practitioner.

The nature of the risk problem being addressed will determine which threats are of interest, and not all threats might need to be modelled or measured. If there are several threats of interest, the process can be applied to each threat in turn or to any number of threats in parallel.

If a target is under attack from several different sources, the results can be aggregated. For example, if a computer is under attack from viruses originating from the Internet and, simultaneously, under attack from viruses originating from other computers on the same local area network (refer to Drawing 3), the net profile of security breaches, disruptions and damage will be the aggregate of the profiles sourced from each threat environment.

Threats can be steady over time or time-varying. For example, the virus threat from the Internet threat environment might be modelled as a steady-state profile whereas the virus threat from the local area network might be modelled as a time-varying profile. In the local threat environment, the threat level rises with time as other computers on the network become infected and, as a result of their infection, become virus threat agents within the local threat environment. The profile of threat agents in the local threat environment would need to be described by functions which take account of the propagation characteristics of viruses within the local threat environment and the (TBSE-calculated) expected rate of successful attacks by the viruses generated within both the local and Internet threat environments, leading to some interesting non-linear threat and risk behaviour.

For each threat and threat environment of interest, specify the relevant risk entities and identify and classify the relevant countermeasure(s) of interest.

The nature of the risk problem being addressed will determine which risk entities and countermeasures are relevant. The objectives of the practitioner will determine which of the relevant risk entities and countermeasures are of interest. Not all relevant risk entities and countermeasures might be of interest and need to be modelled or measured.

The threat is created by the security attacks raining down on the target. There may be several threats besieging the target at any one time. Attacks may be created by external agents (e.g. terrorists, activists, hackers, worm writers, zombie nets), internal agents (e.g. staff, authorised system users) or by serendipity (as with environmental hazards). Attacks can cause one or more security breaches (e.g. intrusion, destruction of property, theft of resources) which can manifest themselves as various different types of disruption according to the nature of the target under attack (e.g. system outage, loss of funds through fraud). The nature of the damage caused by a component, system or process disruption can be measured in various different ways, most often being measured as a financial loss of some form:

Countermeasures are the steps taken to counter threats and the damage they cause. Different countermeasures work in different ways. There are four classifications of countermeasure defined within TBSE:
Ameliorative—these countermeasures work directly on the threat agents or on the dynamics by which threat agents generate attacks to reduce the attack profile in some way. For example, security vetting works to reduce the proportion of active threat agents within the staff population, security deterrence acts to reduce the flux of attacks generated by a given staff population;
Resistive—these countermeasures work directly on the flux of attacks or on the dynamics by which attacks cause security breaches to reduce the profile of security breaches caused by successful attacks. For example, anti-virus software reduces the flux of virus attacks reaching the target system, software patching reduces the vulnerability of an IT system to intrusion attacks, high steel fences increase a building's resistance to physical assault;
Mitigative—these countermeasures work to influence the ability of the security breaches to cause disruptions, usually by reducing the severity of the disruptions caused. For example, having a trained and equipped virus fire-fighting team can reduce the severity of the disruption caused by a successful virus attack, having pre-set arrangements in place with one's bank can increase the proportion of any misappropriated funds which might be recovered;
Alleviative—these countermeasures work to reduce the impact on the organisation caused by possible disruptions. For example, having a fall-back system in place can allow the disrupted business process to continue to operate, albeit perhaps at a reduced level, whilst the disruption caused by an attack is being dealt with; insurance can transfer some if not all of the financial impact of an attack on to the books of the insurer.

This countermeasure classification is shown figuratively in Drawing 2. Generally:
Ameliorative measures reduce the flux of attacks generated by possible threat agents;
Resistive measures reduce the likelihood of the attacks being successful and leading to security breaches;
Mitigative measures reduce the severity of the disruptions manifested as a result of possible security breaches;
Alleviative measures reduce the damage caused by possible disruptions.

Most countermeasures fall into just one class. Any countermeasure which could be considered to cross classes can be modelled as two or more independent countermeasures, each of one class.

The nature of the risk problem being addressed will determine the threats and countermeasures of interest. The practitioner's objective might be to assess the effects of a single countermeasure against a single threat, or to assess the combined effects of several countermeasures countering a particular threat. A practitioner might apply several countermeasures to deter a particular threat but might be interested in modelling the effects of only one of those countermeasures.

For some threats it might be rare for there to be any practicable Ameliorative countermeasures of interest. For example, with generic external threats such as viruses, there are few measures which could be applied by companies to influence the threat agents. Governments can legislate to deter the generation of viruses by virus writers, but companies normally cannot expect to have many levers available with which to influence the behaviour of virus writers. In such a situation, the risk chain used for modelling will likely start from the measured flux of attacks rather than with the Threat Agent risk entity, and modelling would be performed in the absence of any Ameliorative countermeasures.

Hence, any one modelling scenario can be as narrow or as extensive as is needed and involve a greater number or fewer risk entities, generators and countermeasures as is needed to meet the objectives of the practitioner.

For each generator of interest, determine which parameter(s) have a significant influence on the rate at which elements of the parent risk entity generate elements of the child risk entity and on the characteristics of the child elements generated. Then develop the generation functions which describe each of those generators.

Each risk entity is modelled as a probability distribution of elements distributed according to relevant parameter(s). For example:
Burglars (the threat agents for external theft attacks) might be described (in one dimension) according to the probability that a member of the local population (an element of the Threat Agent risk entity) will have a given level of lawlessness;
E-mail viruses (a threat to which systems might be exposed) might be described (in one dimension) according to the probability that an e-mail sent across Internet links (an element of the Attack risk entity) will be carrying a virus of a given age.
E-mail worms (a threat to which systems might be exposed) might be described (in two dimensions) according to the probability that an e-mail sent across Internet links (an element of the Attack risk entity) will be carrying a worm of a given age (in hours) which exploits a software vulnerability of a given age (in days).
System outages (a disruption a system might suffer as a result of a number of different types of attack) might be modelled according to the duration of the outage in hours.
Fraudulent diversion of funds (a disruption a company might suffer as a result of staff misbehaviour) might be modelled in terms of the proportion of the misappropriated funds which are not recoverable.

For some, perhaps for many generators depending on the complexity of the modelling being performed, a generator could be taken to be the identity operator. For example, for worms which exploit software vulnerabilities in the core of the Microsoft Windows operating system, if the target is a Microsoft Windows system which has no countermeasures in place, i.e. is completely unpatched and unfirewalled, it could be taken that any exposure to any worm within the threat will inevitably lead to a successful security attack.

In many other situations, the generator will be a (continuous or discontinuous) function which when applied to the distribution of elements within the parent risk entity will provide the distribution of elements within the child risk entity. For example, the distribution of people within the local population with a given level of lawlessness, α, might be described by a function f=f(α). The generator which describes the rate at which people within the local population of lawlessness a generate security attacks (e.g. theft) with a degree of criminality β might be G(α,β). The theft of weapons-grade nuclear material will clearly be an attack at a higher level of criminality than the theft of a new car which would itself be at a higher level of criminality than shoplifting from a local supermarket). The profile of the security attacks generated by that population of people will then be h(β) where
h(β)=∫_{α}f(α)·G(α,β)·dα

The number of security attacks per capita generated by that population of people will then be
N=∫_{β}h(β)·dβ=∫_{α}f_{β}f(α)·G(α,β)·dα·dβ

A generation function can include parameters which reflect the effect of steps taken, either by people associated with the target or by other parties, either unintentionally or intentionally, which might enhance or modify the generation of child elements, i.e. can be expected to have the effect of increasing the rate of generation of child elements by parent elements or of increasing the magnitude of the parameter values at which child elements are generated.

For example, a government might have measured the profile (rate and distribution in some measure of potency) of hacking attacks at its web servers over a period of time and, by monitoring the origin IP addresses of those attacks, have broken that profile apart to give the different steady-state rates at which the populations of various nations generate various hacking attacks on them. As a consequence, the government would have developed a number of nation-specific generation functions each allowing the profile of the attacks generated by each nation to be calculated as a function of the relevant nation's population. The government might be considering going to war with one or other nation and want to forecast the likely effect on the profile of the hacking attacks it can expect to see in the future. It would reflect within the various nation-specific generation functions how it expects the population of each attacking nation might respond to its declaration of war, with some generation functions showing a marked increase in the rate and/or potency of the attacks generated by the nation's threat agents as a result of belligerent steps taken by the government. The magnitude of the increase might well vary with time as the war becomes extended or as civilian casualties begin to mount.

For each countermeasure of interest, determine which parameter(s) have a significant influence on the effectiveness of the countermeasure at achieving its intended purpose. Then develop the functions which describe each of those countermeasures.

For any countermeasure there are likely to be several parameters which influence the countermeasure's effectiveness but only one or two which have a predominant influence. For example, anti-virus (AV) software works by blocking viruses to which the target system is exposed. The effectiveness of the AV software is determined in part by the promptness with which the vendor releases new virus signatures and this will vary from vendor to vendor as well as from virus to virus. However, for all the market-leading vendors, the difference in promptness between vendors, once averaged over, say, three months' worth of viruses, tends to be small. An alternative parameter such as the frequency with which the user downloads newly released signatures is of much greater influence on the effectiveness of the deployed AV software at blocking the viruses to which the target is exposed. Hence, AV software could well be modelled in terms of the frequency with which the user downloads new signatures and whether the user has one or two different AV software products providing protection, with the identity of the specific AV product or products being ignored as not significant allowing the use of a fixed distribution of new virus signature release times which is independent of AV vendor.

If appropriate, countermeasures can be modelled in terms of several parameters rather than just one. The greater the number of free parameters used in the modelling, the more complex the modelling calculations are likely to be but the greater the potential accuracy of the results.

A countermeasure function can take any of a variety of forms as required to describe the way the countermeasure achieves its effect and the way its effectiveness is influenced by the specific nature of its deployment. For example:
If the population of staff with a given level of lawlessness, α, is described by a function f1=f1(α), and security vetting when applied to such a population reduces the proportion of the population at a given value of α by a fraction C(α,β) for a vetting programme with threshold value β, then the population of staff after security vetting is given by
   f2(α,β)=f1(α)·C(α,β).
If the population of staff with a given level of lawlessness, α, is described by a function f1=f1(α), and the enterprise's security culture when applied to such a population maps elements of the threat agent population (staff) from a lawlessness value α to a lawlessness value α′ described by the function C(α,α′,β) for a culture of strength β, then the population after the security culture has been applied is given by
   f2(α′,β)=∫_{α}f1(α)·C(α,α′,β)·dα
If the population of staff with a given level of lawlessness, α, is described by a function f1=f1(α), and each element of that population generates attacks of degree of criminality φ described by the generation function G(α,φ) then the flux of attacks generated by that population is h1(φ) where
   h1(φ)∫_{α}=f1(α)·G(α,φ)·dα.
If deterrence influences staff behaviour by reducing their inclination to generate attacks of criminality φ by a proportion described by C(α,φ,β) for a deterrent of strength β, then the flux of attacks after the security deterrent has been applied is given by
   h2(φ,β)=∫_{α}f1(α)·G(α,φ)·C(α,φ,β)·dα

Determine the variable(s) with which to profile each risk entity of interest.

The variable(s) for profiling each risk entity will correspond with the parameter(s) used to describe the relevant generation functions and countermeasures of interest. For example:
If the (Resistive) countermeasure used to counter the threat of e-mail viruses is AV software, and if the predominant parameter for that countermeasure is determined to be the frequency with which the user downloads new virus signatures, the variable for profiling the Attack risk entity will be the age of the virus carried by an infected e-mail.
If the Resistive) countermeasure used to counter the threat of Internet worms is software patching, and the predominant parameter for that countermeasure is determined to be the length of the patching cycle operated by the user, the variable for profiling the Attack risk entity will be the age of the vulnerability being exploited by the worm.
If the (Ameliorative) countermeasure used to counter the ability of staff (the threat agent) to generate security attacks is security vetting, and the predominant parameter for that countermeasure is determined to be the threshold level of lawlessness at which a member of staff is deemed to have failed the vetting, the variable for profiling the population of threat agents will be their degree of lawlessness;
If the (Mitigative) countermeasure used to counter the ability of virus infections to cause system disruptions is having a trained virus fire-fighting team ready for deployment at a moment's notice, and the predominant parameter for that countermeasure is deemed to be the fire-fighting team's ability to speed up the process of removing the virus and restoring the system to normal operation, the variable for profiling the security breaches caused by virus infections will be the time taken by an untrained user to clear the infection and restore their system.

Develop the functions which describe each child risk entity of interest in terms of preceding risk entities, generators and countermeasures.

Again, the nature of the risk problem being addressed will determine which risk entities are of interest and to be modelled.

For example, if the distribution of elements within the parent risk entity is f(α), the generator which describes the rate at which elements of the parent with value α generate elements of the child at value β is G(α,β), and the countermeasure being used to impede the rate at which elements of the parent are successful at generating elements of the child is described by C(α,β,γ) for a countermeasure setting of γ, then the profile of the child (the distribution of child elements in variable β for any given countermeasure setting γ) will be h(β,γ) where
h(β,γ)=∫_{α}f(α)·G(α,β)·C(α,β,γ)·dα
and the number of elements in the child per element in the parent will be
N=N(γ)=∫_{β}h(β, γ)·dβ=∫_{α}∫_{β}f(α)·G(α,β)·C(α,β,γ)·dα·dβ

This the practitioner can use to show the benefit of the countermeasure in terms of how different levels of deployment of the countermeasure (i.e. different values of γ) can lead to different numbers of elements within the risk entity (e.g. different rates of attack or different levels of security breach occurring).

This description can easily be extended to cover entities profiled in more than one dimension and subject to more than one countermeasure. For example, for a parent entity described in two dimensions by f(α,β), which generates a child entity described in two dimensions by h(γ,δ) according to a generation function G(α,β,γ,δ), subject to countermeasures described by C(α,β,γ,δ,ε) and D(α,β,γ,δ,φ), then the profile of the child entity (as a function of the countermeasure settings ε and φ) will be
h(γ,δ,ε,φ)=∫_{α}∫_{β}f(α,β)·G(α,β,γ,δ)·C(α,β,γ,δ,ε)·D(α,β,γ,δ,φ)·dα·dβ
and the number of elements in the child per element of the parent (as a function of the countermeasure settings ε and φ) will be
N=N(ε,φ)=∫_{γ}∫_{δ}h(γ,δ,ε,φ)·dγ·dδ

Clearly, it is in the interests of the modelling to develop countermeasure and generator descriptions which are simple as well as sufficiently accurate for purpose, and to perform the modelling over just those parameters which have the most significant affect on the results.

Measure and profile the relevant parent risk entity(entities).

Measure each relevant risk entity in the risk chain in terms of its profile in the relevant parameter(s).

The nature of the risk being modelled will determine which risk entities are relevant, and not all risk entities might need to be measured or might be practicably measurable. For example, if the risk being modelled is the risk of e-mail viruses coming from the Internet getting past the target's AV software, the Disruption and Damage risk entities are not of interest and do not need to be measured. The target company might not be interested in applying any Ameliorative countermeasures and might decide it is not practicable for it to measure the population of threat agents (virus writers) generating Internet-distributed viruses, in which case it would need only to measure the Internet e-mail virus threat, i.e. the profile of the relevant Attack risk entity, but not attempt to measure the profile of the relevant threat agents.

The purpose of the modelling might be to calculate the likelihood of a specific security breach as a function of the strength of the countermeasures applied. The practitioner might not be interested in comparing his risk results with the level of security breaches actually experienced, in which case he might decide not to measure the current or past profile of the Security Breaches risk entity.

These risk entity measurements can be performed by the practitioner or by a third party service provider. Drawing 4 shows an example threat profile for an e-mail virus threat. Drawing 5 shows an example threat profile for Internet-originated worms exploiting the LSASS vulnerability (BID 10108).

The profile ordinate is the probability per unit that the target will experience the relevant element at the given variable value. The probability unit will depend on the risk entity concerned. For example, it might be the probability of exposure per hour, it might be the probability of exposure per day per exposed IP address, it might be the probable rate of occurrence per day per 100 members of staff.

The profile abscissa is the variable (or variables) against which the risk entity is being profiled. The risk entity might be profiled in just one dimension (e.g. the rate of exposure to e-mail viruses profiled as a function of the age in hours of the virus carried by the e-mail) or in more than one dimension (e.g. the rate of exposure to Internet worms profiled as a function of the age in hours of the worm since it was first detected in the wild AND as a function of the age in days of the vulnerability being exploited by the worm).

Again, depending on the nature of the risk being modelled and the objectives of the practitioner, it might not be practicable or suitable for the profile of each risk entity to be measured. In such cases, needed parent risk entity profiles can be postulated, if that is suitable, or can themselves be calculated from the preceding risk entities, generation functions and countermeasures in the risk chain.

Use the measured, profile of the parent risk entity to calculate the expected profile of each subsequent child risk entity of interest, each as a function of the parameters used to describe the generation function(s) and countermeasure(s) previously identified.

Use the measured profile of the parent risk entity in the relevant equations described above to calculate the expected form and magnitude of the child risk entity. This step can be used by the practitioner to calculate how the magnitude or profile of the child will vary as the intervening countermeasures are varied or as assumptions contained within the generation functions are varied. For example:
Measuring the profile of the population of the company's staff will enable the practitioner to show how the rate and potency of internal security attacks can be affected by countermeasures such as security vetting, security deterrence and strengthening the security culture;
Measuring the flux of e-mail worms will enable the practitioner to compare the relative benefits of improved AV software protection and improved software patching on the rate of successful worm intrusions;
Measuring the annual number and duration of virus infections suffered will enable the practitioner to show the benefits of increased training for the virus fire-fighting team;
Measuring the losses due to fraud can enable the practitioner to compare the benefits of, on the one hand, fraud reduction through improved user authentication and access control with, on the other hand, fraud reduction through improved financial detection controls.

This step can be performed for the immediate child of the measured parent or for subsequent children in the chain down from the measured parent. It can be used to show the effects of countermeasures applied to the step in the risk chain in which the child is to be found or for any other countermeasure in a preceding step between the measured parent and the particular child of interest.

If the risk entity measured is itself the child of a more senior parent risk entity, this step can be used to imply the magnitude and/or profile required of a more senior parent in order to generate the child in the form as measured (assuming the relevant generation function is well known), or to imply the characteristics of the generation function (if the profile of the parent is well known), or to indicate the likely strengths of each where neither is known well. For example:
Measuring the rate of internal security attacks and the company's staff profile can enable the practitioner to benchmark the strength of his company's security culture against the norm;
If the company's key resistive countermeasures have been calibrated, measuring the rate of successful internal security attacks can enable the practitioner to infer the present rate of internal security attacks and possibly the profile of the company's current staff population.

If appropriate, measure the profile of relevant child risk entities and compare the measured profiles with the expected profiles calculated.

Measuring the profile of a parent and immediate child and comparing the calculated profile of the child with the measured profile of the child can allow the practitioner to calibrate the effectiveness of key countermeasures between the parent and child or to check the accuracy of the modelling and forecasting being performed. This can be valuable when determining which security metrics to focus upon, when setting security metrics targets to be achieved, and when deciding whether the parameters selected for the modelling are sufficient or correct

From the profile of each child risk entity, form the risk indices or other moments of interest. Calculate how these indices or moments vary as a direct function of the measured input risk entities (e.g. the threat) and the generator and/or countermeasure parameters.

Once the profile of a risk entity has been measured or calculated, various indices which bring out particular characteristics of the risk entity, or various moments which quantify the distribution of elements within the risk entity, can be calculated. Moments can include the 1^{st} order moment (the number of elements within the child). For example:
Security risk, in the form of the probability of specific security breaches occurring, can be calculated from the number of elements in the relevant Security Breach risk element.
For profiles which usually display a characteristic shape, such as the profile of e-mail viruses, an index can be created such as the proportion of all e-mails which carry a virus of age less than or equal to 48 hours. This index can be tracked to give a general indication of the present level of risk from e-mail viruses in much the same way as an equity market index is tracked to show the general state of the equity market.

### EXAMPLES

Modelling The Use of Anti-Virus Software Protecting Against The E-Mail Virus Threat

1 For each threat of interest, specify the relevant risk entities and identify and classify the relevant countermeasure(s) of interest.
   The threat of interest in this case is the threat of infection from Internet e-mail viruses. The practitioner's objective is to evaluate the benefit of desktop anti-virus (AV) software and how to configure that software to give the desktop a required level of protection against viruses brought in on e-mails from the Internet.

The target is the desktop receiving e-mails from the Internet. Refer to Drawing 6. The relevant risk entities are:

| | |
|---|---|
| Threat Agents: | Not relevant |
| Attacks: | E-mails carrying viruses |
| Security Breaches: | An infection of the desktop |
| Disruptions: | Not relevant |
| Damage: | Not relevant |

The countermeasure is AV software. It is a resistive countermeasure in that it helps to prevent the attacks being successful at the target and creating security breaches.
2 For each generator of interest, determine which parameter(s) have a significant influence on the rate at which elements of the parent risk entity generate elements of the child risk entity and on the characteristics of the child elements generated. Then develop the generation functions which describe each of those generators.
   We shall presume that the generator is the unity operator, i.e. any virus which makes it past the AV software will cause an infection.
3 For each countermeasure of interest, determine which parameter(s) have a significant influence on the effectiveness of the countermeasure at achieving its intended purpose. Then develop the functions which describe each of those countermeasures.
   Desktop AV software is a mature product in a market with several well established market leading vendors. All market leading products can be taken to be 100% effective at recognising and blocking an e-mail virus provided the virus' signature is contained within the signature file held locally on the desktop. Hence, the specific vendor of the AV product is not a significant parameter for the modelling.
   The main parameter which determines the effectiveness of AV software at blocking viruses is the period between successive downloads by the user of new virus signatures onto the desktop. We shall, for simplicity of example, model the countermeasure in terms of just this one parameter.
   To create the function which describes the countermeasure, we will also need to know the average delay between the appearance of a new virus in the wild and the release of that new virus' signature by the AV vendor. We shall call this delay T_{Vendor} and assume that it is readily measurable. We shall call the interval between the user's successive signature downloads β. β is a variable controlled by the user.
   We will assume that the probability of the desktop AV software successfully blocking a virus when the desktop is exposed to that virus is 0% if the AV vendor has not yet released the signature for that virus, is 100% if the signature has been released and the user is certain to have downloaded it, and is between 0% and 100% if the signature has probably been released but it is not certain the user will have downloaded it yet. We shall refer to this probability as the resistance that the AV software confers, i.e. the target's resistance to e-mails as conferred by the AV software. We shall presume that the user does not correlate their checks for new signatures with the release of signatures by the vendor, i.e. the vendor releases new signatures as and when they are ready for release and the user checks for new signatures to download every P hours without knowing whether or when the vendor recently released a fresh signature. Under these assumptions, we can model the resistance function describing the countermeasure as shown in Drawing 7, where α is the age of a virus (in hours) to which the target is exposed.
   Drawing 7 shows that the resistance conferred by the AV software is essentially 0% for α<T_{Vendor}, is essentially 100% for α>T_{Vendor}+β, and rises linearly from 0% to 100% for T_{Vendor}<α<T_{Vendor}+β. We can smooth out the transitions at α=T_{Vendor} and α=T_{Vendor}+β, owing to the inherent variability in the actual signature release time around the central value T_{Vendor}.
   We shall decide that for our current purposes, the function shown in Drawing 7 gives us a sufficiently accurate description of the countermeasure for our modelling needs. If we wished to measure the vendor release times more accurately, we would find that we could form a more accurate description of the resistance function based on those measurements (where, for example, we might find that the value of the resistance for α<T_{Vendor} is closer to 10% than 0% due to the chance that a new virus when it first appears is already covered by an existing signature in the user's local AV signature file).
4 Determine the variable(s) with which to profile each risk entity of interest.
   The two risk entities of interests are the Attack and Security Breach risk entities, where the Attack risk entity is the parent and the Security Breach risk entity is the child.
   We determine that the variable for profiling the Attack risk entity is the age of the virus, and this we shall denote by α, i.e. the profile of the Attack risk entity will be the probability that an e-mail arriving at the desktop is carrying a virus of age α.
   We will be interested only in the probability that the target will become infected, not in the nature of the infection caused, as we will not be modelling any further risk chain stages. Hence, we do not need to concern ourselves with any suitable variable for profiling the Security Breach risk entity.
5 Develop the functions which describe each child risk entity of interest in terms of preceding risk entities, generators and countermeasures.
   Let us denote the profile of the parent by n(α) where n(α) is the probability that an e-mail arriving at the target carries a virus of age α.
   ∫n(α)·dα is then the expression for the probability that an Internet e-mail is carrying a virus of any age, and that will typically be in the range 1% to 10% given current threat levels.
   The probability that a virus of age a will get blocked by the AV countermeasure is R(α,β) (refer to Drawing 7) where β is the period between successive signature downloads by the user. Therefore, the probability that the virus of age α will get past the AV countermeasure to infect the target is P(α,β) where P(α,β)=1−R(α,β). The probability that the target will get infected by the e-mail irrespective of the age of the virus is then N(β) where
      N(β)=∫n(α)·P(α,β)·dα
   N(β) is clearly a variable in β, i.e. will vary according to the rate at which the user downloads new virus signatures. We can expect that it will grow as β grows.
6 Measure and profile the relevant parent risk entity(entities).
   At this stage we measure the flux of e-mail viruses arriving at the target as a function of the age of the virus. This can be performed very accurately by e-mail service providers who typically manage several billions of e-mails a year and can accurately form the Attack profile for a typical Internet-connected desktop. Let us, for this example, presume that that has been done and the profile obtained is as shown in Drawing 8.
7 Use the measured profile of the parent risk entity to calculate the expected profile of each subsequent child risk entity of interest, each as a function of the parameters used to describe the generation function(s) and countermeasure(s) previously identified.
   With the measured value of n(α) we can perform the calculation in step 5 for any chosen value of T_{Vendor}. We will determine the value of T_{Vendor} by measurement (at the time of writing recent measurements give a value of approximately seven hours). This gives us a chart which shows how the probability per e-mail of the target becoming infected varies as a function of the time taken by the user to download new virus signatures. Maybe it will look as shown in Drawing 9.
8 If appropriate, measure the profile of relevant child risk entities and compare the measured profiles with the expected profiles calculated.
   We shall choose not to do this at the present time.
9 From the profile of each child risk entity, form the risk indices or other moments of interest. Calculate how these indices or moments vary as a direct function of the measured input risk entities (e.g. the threat) and the generator and/or countermeasure parameters.
   A typical value for T_{Vendor} is seven hours and a typical value for βis 24 hours. On this basis, one threat index of interest is the proportion of e-mails which carry a virus which is 48 hours old or less. This gives a general index of the level of risk engendered by the present threat. Any viruses older than 48 hours are almost certainly not going to create any risk for the target as the user will almost certainly have downloaded the signatures for all viruses of that age or: older. Hence, this index is a better indicator of the risk level carried by the present threat than the conventional threat index (the proportion of e-mails carrying a virus of any age) as those viruses which are older than 48 hours do not create any risk for the target yet would still be counted by the conventional index.
   Other results besides that shown in Drawing 9 can be calculated. For example, as the result calculated initially is the probability of infection per e-mail given the present threat and the user's download frequency, a result which is the risk of infection per month can be calculated if the user's monthly e-mail volume is known. This might look like the results shown in Drawing 10 which shows the risk of infection as a function of the user's update period (in hours) for several different monthly e-mail volumes.
      Modelling the use of Security Vetting to Protect Against the Threat from Staff Knowingly Violating an Applicable Code of Practice

For each threat of interest, specify the relevant risk entities and identify and classify the relevant countermeasure(s) of interest.
The threat of interest is the threat from security attacks generated by a staff population. The Threat Agent risk entity is the staff population, the Attack risk entity is the internal security attacks which that population generates, the countermeasure is Security Vetting, and it is an Ameliorative countermeasure.
   For each generator of interest, determine which parameter(s) have a significant influence on the rate at which elements of the parent risk entity generate elements of the child risk entity and on the characteristics of the child elements generated. Then develop the generation functions which describe each of those generators.
People the world around have an inherent tendency to break the rules, whether those rules are the unwritten rules of the community of which they are a member, the written rules of the club of which they are a member, the unwritten code of behaviour (culture) or written code of authorised behaviour of the company by which they are employed, or the written statutes which apply within the jurisdiction they work under (e.g. the Official Secrets Act, the laws of the land). Some people are more inclined to break the rules than others, and some will break them to a greater degree than others.
We can describe the staff population according to a parameter which we will call lawlessness (ω), and the attacks they generate according to a parameter which we will call criminality (φ), and take the generation function describing the probability that a member of staff of lawlessness ω will be prepared to generate attacks of criminality φ to be G(ω,φ). We estimate G(ω,φ) to be as described in Drawing 11. We estimate the rate at which each member of staff generates attacks to be that probability multiplied by a constant scaling factor N where N is to be determined in the future by measurement and calibration.
   For each countermeasure of interest, determine which parameter(s) have a significant influence on the effectiveness of the countermeasure at achieving its intended purpose. Then develop the functions which describe each of those countermeasures.
The one countermeasure of interest is security vetting. Vetting works by evaluating the level of lawlessness of each member of the threat agent population and removing from that population all those elements which are adjudged to have a degree of lawlessness above a given threshold value. The accuracy with which the vetting process estimates the element's lawlessness is a function of the effort put in to the vetting.
With this view of how vetting works, we can describe this countermeasure with a function C(ω, ω̅,ε) where C(ω, ω̅,ε) is the probability that a member of staff of lawlessness ω will pass successfully through the vetting (i.e. not be culled), where ω̅ is the threshold value of lawlessness at which we start to cull the population and ε is the level of effort put into each vetting exercise. We estimate C(ω, ω̅,ε) to be as shown in Drawing 12 (shown for ω̅=5).
   Determine the variable(s) with which to profile each risk entity of interest
It is clear from the modelling scenario we have constructed that we should model the parent risk entity according to the parameter we are calling lawlessness and the child risk entity according to the parameter we are calling criminality.
We could also decide to invoke an additional parameter for each risk entity which we call skill. We might decide that each element of the parent risk entity of lawlessness ω and skill γ will generate elements of the child risk entity (internal security attacks) of criminality φ and skill γ according to a generation function similar to that described above. For simplicity of example, we will drop the skill parameter from the remainder of this example's discussion.
   Develop the functions which describe each child risk entity of interest in terms of preceding risk entities, generators and countermeasures.
Let us describe the profile of the parent by a function f=f(ω). Perhaps this will have the form shown in Drawing 13. Note that
   ∫_{ω}f(ω)·dω=100%
The rate at which this population will generate attacks of criminality φ in the absence of any security vetting is h(φ) where
   h(φ)=N∫_{ω}f(ω)·G(ω,φ)·dω
where N and G(ω,φ) are as described above. When security vetting is applied, this rate is modified and becomes h(φ, ω̅,ε) where
   h(φ, ω̅,ε)=N∫_{ω}f(ω)·G(ω,φ)·C(ω, ω̅,ε)·dω
ω̅, ε and C(ω, ω̅,ε) are as described above, and the rate is per head of the original unvetted staff population. Where vetting culls members of that original population, the size of the vetted staff population will be less than the original size of the unvetted population.
   Measure and profile the relevant parent risk entity(entities).
The profile to be measured is the profile of lawlessness of the unvetted staff population. We can assume in the absence of any security culture, deterrence or other relevant countermeasures that this profile is the same as for the population at large from which the employees are drawn. Various law enforcement bodies will have measured that profile and have extensive data of their own though possibly in a form which will require some further analysis to convert it into a profile in lawlessness as required here.
   Use the measured profile of the parent risk entity to calculate the expected profile of each subsequent child risk entity of interest, each as a function of the parameters used to describe the generation function(s) and countermeasure(s) previously identified.
Using the profile provided by a law enforcement agency, or as otherwise measured, we can calculate the expected profile of attacks as a function of the way security vetting is applied. We will find that the benefits of using security vetting are fairly evenly balanced between reducing the expected rate of attacks and reducing the expected degree of criminality of attacks, with it perhaps having slightly more effect on attack criminality than on attack rate. Strengthening the accuracy of security vetting consumes more effort by the vetting organisation and is fairer on staff but appears to have almost no benefit in terms of the end results achieved.
If we were to perform a similar analysis of the benefits of two other countermeasures, strengthening an enterprise's security culture and applying security deterrence, we would find that strengthening an enterprise's security culture reduces the rate of attacks more than it reduces the criminality of those attacks, and that deterrence has a relatively strong effect on the rate of attacks but only a relatively small effect on the expected criminality of attacks.
These results suggest that deterrence alone can reduce the target's risk only to the degree that it can reduce the expected rate of attacks. To reduce the risk further, a mixture of countermeasures is needed designed to achieve a reduction in the expected level of attack criminality too. Strengthening the security culture looks to be the single most effective countermeasure an organisation can deploy.
   If appropriate, measure the profile of relevant child risk entities and compare the measured profiles with the expected profiles calculated.
The target enterprise's management might decide that, in the light of the above results, they would measure the profile of attacks the enterprise currently suffers and then the profile of attacks it suffers six months later in order to gauge the benefits of the security vetting programme they are about to initiate. If they find that their vetting effort does not achieve the desired reduction in attack profile, rather than strengthening their vetting they might decide to strengthen either their security culture or security deterrents and then to measure the attack profile again six months after that.
   From the profile of each child risk entity, form the risk indices or other moments of interest. Calculate how these indices or moments vary as a direct function of the measured input risk entities (e.g. the threat) and the generator and/or countermeasure parameters.
Given the interest in both the rate and level of criminality of attacks, a useful index of the threat agent population might be the average degree of lawlessness of staff members, and a useful index of the attack population might be the aggregated measure of criminality summed over all attacks.
   An Implementation of the Invention in Software

The invention could be implemented in the form of a software system hosted on a corporate IT network. The purpose of the system could include controlling certain components on the IT network in such a manner as to maintain the security risks to the IT network below threshold values set from time to time by a corporate risk manager.

The system would comprise a Management Station containing a database and TBSE calculation software, various security assessment devices as required and various feeds providing current threat data for one or more threats of interest.

The security assessment devices would be designed to measure the current status of each of a number of relevant countermeasures. For example, one device might measure the current strength of user passwords by periodically running active password databases through a standard password cracking utility. Another device might measure the current patch levels of key servers on the IT network. Another device might measure how long it has been since each firewall was last tested.

The threat data feeds could be provided by external service providers or by the company's own threat measurement sensors distributed appropriately around the IT network. External service providers might provide feeds describing the threat profile for viruses, worms, hacking attacks, Denial of Service attacks, etc. for the Internet threat environment. Internal sensors might provide feeds describing the threat profile for each of these threats within different internal threat environments, plus feeds for other threats within each of the internal threat environments such as the profile of staff attempts to gain unauthorised access to company IT systems, or of staff abuse of corporate Internet browsing facilities.

The database would contain an entry for each valued IT asset within the company's infrastructure and an entry for each countermeasure deployed within the infrastructure. Each asset entry would identify the threat environment in which the asset resided, the threats against which the asset is to be protected, the protection targets which are to be met, and would include the identity and relevant information for each countermeasure protecting that asset. Each countermeasure entry would contain information describing the present configuration of the countermeasure as required for the TBSE risk modelling, and the countermeasure's current settings, where the setting might be a value set by the security risk manager or a value determined by an appropriate risk assessment device.

The management station's TBSE software would be configured to calculate the expected profile (likelihood and distribution) of each of the threats from the threat feeds and of each of a wide variety of security breaches resulting from the threats prevailing within each threat environment, with the profile of each security breach being calculated for each threat of interest within each threat environment for the current settings of each of the relevant countermeasures. The software would calculate risk indices and protection levels of interest for each of the threat or security breach profiles and compare the protection levels with the protection targets set by the security risk manager. The management station would have a facility for calculating the expected profiles of each of the threats or security breaches for altered settings of the countermeasures so the effect of varying the countermeasures on the predicted risk indices or protection levels can be calculated.

The management station would take in information about the present threats from the threat feeds. From these it would form the profiles of each of the threats measured. Knowing which countermeasures were protecting each threat environment and the present settings of each countermeasure, the management station would be able to calculate the profile of each of the security breaches of interest for each of the threat environments.

The company's risk manager would input into the management station the company's protection targets for each IT asset in the form of the maximum likelihood results for each security breach at each asset which the company is prepared to tolerate. The management station would compare the calculated results with the input protection targets and flag in a report each of the targets which is either being exceeded given the present threat levels or is close to being exceeded. Either automatically or manually by the risk manager, the software would calculate what the results would be for various different countermeasure settings and would use these new results to determine the optimal countermeasure adjustments needed to keep the risk indices and protection levels within the targets given the present threat levels. Either automatically or manually, countermeasures could be adjusted (e.g. anti-virus software set to check for new updates with a different frequency) or other components on the IT network could be adjusted (e.g. the rate at which e-mails are received from the Internet could be throttled back) to achieve the protection levels required.

Appendix 1 Core Features

This invention:

1. Introduces the idea of the risk chain and the risk chain structure for understanding the security dynamics which lead from threat agents to the damage caused by successful attacks.
2. Uses the risk chain structure for understanding how different countermeasures can influence the results of the threats, and introduces the classification scheme, for countermeasures which classifies countermeasures according to which risk chain stages they influence.
3. Shows how to describe countermeasures analytically according to the key parameters which determine the magnitude of the effects the countermeasure achieves.
4. Introduces the idea of generation functions which describe how some risk entities generate other risk entities, and shows how to describe generation functions analytically according to relevant parameters as needed for modelling and forecasting.
5. Shows how to define the profile of a threat in preparation for modelling and forecasting and in a way which exposes the risk contributions made by each element of the threat.
6. Shows how to measure the present threat and form indices for the present threat which expose the level of risk rather than simply the magnitude of the threat and allow risk-oriented rather than simply volume-oriented threat indices to be tracked.
7. Shows how to define the profile of security breaches and process/system disruptions in order to model analytically the expected level of damage caused by the threats.
8. Shows how to calculate the expected profile likelihood and distribution) of specific attacks, security breaches, disruptions and damage in numerical form rather than in the conventional subjective immeasurable form, as a function of the parameter(s) which determine(s) the strength of each security countermeasure.
9. Shows how to form indices of interest such as risk indices for specific threats.
10. Enables the practitioner to show and quantify the benefits of specific countermeasures in terms of the reduction in the profile (magnitude or distribution of characteristics) of specific risk entities they achieve for a given level of threat.
11. Enables the practitioner to optimise countermeasures, e.g. to vary each of a number of countermeasures in order to minimise the operational impact or cost of the group of countermeasures whilst continuing to achieve set security targets.
12. Enables the practitioner to calibrate security countermeasures in objective terms relating to the magnitude of the impact achieved by the countermeasure on risk indices, thereby allowing an objective scale of evaluation levels to be constructed.
13. Enables the practitioner to benchmark countermeasures when normalized against a standard level of threat.
14. By determining the cost savings achieved by the expected reduction in the aggregate impact of security breaches caused by a threat and the costs that would be incurred in strengthening the security countermeasures by the required amount to achieve that reduction, calculate the Return on Investment achieved by the proposed security improvement.
   Appendix II—Examples of Risk Entity Parameters

The risk entity parameters are selected by the practitioner as needed to suit their specific risk scenario and modelling objectives. Hence, any risk entity can be modelled according to a variety of pertinent parameters and these may well vary from scenario to scenario, especially if the same set of risk entities are being used to model the effects of different countermeasures. The following shows some illustrative examples of possible risk entity parameters.

Virus writers launching e-mail viruses into the wild which infect IT systems and cause those systems to crash:

| Risk Entity Type | Risk Entity | Possible Parameter(s) |
|---|---|---|
| Threat Agent | Virus writers | Inclination |
| Attack | Viruses | Age of the virus |
| Security Breach | Infections | Payload potency |
| Disruption | System crash | Time to recover |
| Impact | Increased costs incurred | Amount in local currency |

Hackers launching phishing attacks against the users of web systems and stealing customer account authentication information:

| Risk Entity | | |
|---|---|---|
| Type | Risk Entity | Possible Parameter(s) |
| Threat Agent | Hackers | Lawlessness; skill |
| Attack | Phishing attacks | Appearance of authenticity |
| | | and legitimacy |
| Security | Capture of account | Total number of accounts |
| Breach | information | compromised |
| Disruption | Reduced reliability of | Total proportion of accounts |
| | customer authentication | not recovered |
| | processes | |
| Impact | Loss of revenues | Net value lost in local |
| | | currency |

Hackers launching hacking attacks against web commerce systems and stealing customer credit card information:

| Risk Entity | | |
|---|---|---|
| Type | Risk Entity | Possible Parameter(s) |
| Threat Agent | Hackers | Lawlessness; skill |
| Attack | Hacking attacks | Age of the exploit; Age of the |
| | | vulnerability being exploited |
| Security | Unauthorised access to | Number of accounts |
| Breach | customer credit card | compromised; Effort needed to |
| | details | calm customer anxieties |
| Disruption | Reduced prospective | Shortfall below forecast of rate |
| | customer willingness | of enrolment of new customers |
| | to enrol with and use | |
| | web systems | |
| Impact | Loss of expected | Net value lost in local currency |
| | revenues | |

Zombie nets launching Denial of Service attacks against company electronic storefronts causing customer services to be over-burdened or shut down temporarily:

| Risk Entity | | |
|---|---|---|
| Type | Risk Entity | Possible Parameter(s) |
| Threat Agent | Zombie computers | Rate of generation of attacks |
| | | (transactions per second) per |
| | | zombie |
| Attack | Flood attacks | Aggregate rate of arrival of attack |
| | | (transactions per second) |
| Security | Systems' capacity | Capacity volume consumed (% of |
| Breach | diverted | full capacity diverted times |
| | | duration) |
| Disruption | Delayed servicing of | Average customer delay |
| | legitimate customer | experienced |
| | requests | |
| Impact | Impaired customer | Average interval between a |
| | loyalty | customer's successive visits |

Staff abusing their position of authority to defraud their company through abuse of payment systems:

| Risk Entity Type | Risk Entity | Possible Parameter(s) |
|---|---|---|
| Threat Agent | Staff | Lawlessness |
| Attack | Attempts to subvert | Level of criminality |
| | payment system | |
| | controls | |
| Security Breach | Unhindered use of | Stealth (expected delay before |
| | payment system | actions are detected by |
| | facilities | monitoring reporting and audit |
| | | systems) |
| Disruption | Misappropriation of | Proportion of misappropriated |
| | funds | funds not readily recoverable |
| Impact | Loss of financial | Annual aggregate loss (dollars) |
| | | assets |

Professional cat burglars breaking in to houses and stealing valuables:

| Risk Entity | | |
|---|---|---|
| Type | Risk Entity | Possible Parameter(s) |
| Threat Agent | Burglars | Fear of being caught |
| Attack | Burglary expeditions | Adeptness (at picking locks, at |
| | | disabling alarm systems) |
| Security | Break ins to houses | Freedom of movement (square |
| Breach | | feet); ability to locate and access |
| | | valuables |
| Disruption | Theft of valuables | Proportion of value at risk which |
| | | is stolen |
| Impact | Losses | Irreplaceable sentimental value, |
| | | net replacement cost |

Corporate espionage conducted by bugging competitors' offices:

| Risk Entity Type | Risk Entity | Possible Parameter(s) |
|---|---|---|
| Threat Agent | Corporate espionage | Technical expertise |
| | experts | |
| Attack | Bugging expeditions | Security clearance of personnel |
| | | involved in the attack |
| Security Breach | Installation of | Stealthiness of operational bug |
| | operational bugs | (difficulty in its being detected |
| | | when in operation) |
| Disruption | Theft of secret | Strategic criticality of secret |
| | information | information |
| Impact | Loss of competitive | Loss of enterprise value |
| | advantage | |

An infantry division attacking soldiers defending a town:

| Risk Entity | | |
|---|---|---|
| Type | Risk Entity | Possible Parameter(s) |
| Threat Agent | Division of riflemen | Courage under fire |
| Attack | Shots fired at | Calibre of the shots |
| | defending soldiers | |
| Security | Defenders being hit | Severity of wound |
| Breach | | |
| Disruption | Capacity to defend | Ratio between rate of reduction |
| | reduced | and ability to bolster capacity with |
| | | reinforcements |
| Impact | Loss of control of | Strategic value of territory lost |
| | territory | |

1. A method used in the control of a physical system, comprising the steps of
(a) modelling a risk chain, the risk chain being a series of two or more entities that each model a discrete part of how a threat leads to damage to a target system, each entity being described as a population of elements distributed in a parameter or parameters, each entity generating the next entity in the chain; and
(b) controlling the physical system by using results of the modelling.

2. The method of claim 1 in which the way one entity in the risk chain generates another entity in the risk chain is described by a quantitative generation function.

3. The method of claim 1 comprising the further step of modelling countermeasures to one or more entities in the risk chain, each countermeasure being quantitatively described as a function of one or more variables.

4. The method of claim 3 comprising the further step of deploying a countermeasure to an entity in such a manner so that the effect of the entity is diminished to a defined, quantitative level.

5. The method of claim 3 in which the or each variable describing a countermeasure determines the efficacy of that countermeasure in modifying the population of elements in an entity or influencing how one entity in the risk chain generates another entity in the risk chain.

6. The method of claim 3 in which the deployment of countermeasures is quantitatively optimised.

7. The method of claim 1 in which the distribution of elements of an entity in a parameter is a measured distribution.

8. The method of claim 7 in which the measured distribution is a real-time measured distribution.

9. The method of claim 7 in which the measured distribution is compared to a predicted distribution, the comparison enabling the accuracy of an algorithm used to make the prediction to be improved.

10. The method of claim 1 in which the controlled system is controlled by being dynamically altered on the basis of the modelling.

11. The method of claim 10 in which the controlled system is dynamically altered based on measurements of the distribution of elements in one or more parameters.

12. The method of claim 3 in which each entity in the risk chain is an entity with substantially the properties of an entity selected from the following list of entity types: threat agents; attacks; security breaches; disruptions; damage.

13. The method of claim 12 in which the countermeasure that modifies the threat agent entity or influences the output of that entity is an ameliorative measure.

14. The method of claim 12 in which the countermeasure that modifies the attack entity or influences the output of that entity is a resistive measure.

15. The method of claim 12 in which the countermeasure that modifies the security breach entity or influences the output of that entity is a mitigative measure.

16. The method of claim 12 in which the countermeasure that modifies the disruption entity or influences the output of that entity is an alleviative measure.

17. The method of claim 1 in which the target system is a computer.

18. The method of any preceding claim 1 in which the target system is a computer network.

19. The method of claim 1 in which the target system is a telecommunication system.

20. The method of claim 1 in which the target system is a mobile communications device or personal digital assistant.

21. The method of claim 1 in which the target system is a building, group of buildings, physical infrastructure, means of transport or a transport infrastructure, aircraft or vehicle.

22. The method of claim 1 in which the target system is a physical storage container.

23. The method of claim 1 in which the target system is a business, business process or business system.

24. The method of claim 1 in which an entity in the risk chain describes a population of one or more people who seek or otherwise obtain unauthorised access to the target system or who seek to or otherwise influence it in an unauthorised manner.

25. The method of claim 1 in which an entity in -the risk chain describes a population of one or more computer viruses or worms or Trojan Horses or computers.

26. The method of claim 25 in which a parameter is the age of the virus.

27. The method of claim 1 in which an entity of the risk chain describes a population of one or more fires, floods, earthquakes or other physical acts which have an impact on the target system.

28. A method of modelling a specific security threat to a system, comprising the step of modelling a risk chain, the risk chain being a series of two or more entities that each model a discrete part of how a threat leads to damage to the system, each entity being described as a population of elements distributed in a parameter or parameters, each entity generating the next entity in the chain.

29. The method of claim 28 in which the way one entity in the risk chain generates another entity in the risk chain is described by a quantitative generation function.

30. The method of claim 28 comprising the further step of modelling countermeasures to one or more entities in the risk chain, each countermeasure being quantitatively described as a function of one or more variables.

31. The method of claim 30 comprising the further step of deploying a countermeasure to an entity in such a manner so that the effect of the entity is diminished to a defined, quantitative level.

32. The method of claim 30 in which the or each variable describing a countermeasure determines the efficacy of that countermeasure in modifying the population of elements in an entity or influencing how one entity in the risk chain generates another entity in the risk chain.

33. The method of claim 30 in which the deployment of countermeasures is quantitatively optimised.

34. The method of claim 28 in which the distribution of elements of an entity in a parameter is a measured distribution.

35. The method of claim 34 in which the measured distribution is a real-time measured distribution.

36. The method of claim 34 in which the measured distribution is compared to a predicted distribution, the comparison enabling the accuracy of an algorithm used to make the prediction to be improved.

37. The method of claim 28 in which the system is controlled by being dynamically altered on the basis of the modelling.

38. The method of claim 37 in which the controlled system is dynamically altered based on measurements of the distribution of elements in one or more parameters.

39. The method of claim 30 in which each entity in the risk chain is an entity with substantially the properties of an entity selected from the following list of entity types: threat agents; attacks; security breaches; disruptions; damage.

40. The method of claim 39 in which the countermeasure that modifies the threat agent entity or influences the output of that entity is an ameliorative measure.

41. The method of claim 39 in which the countermeasure that modifies the attack entity or influences the output of that entity is a resistive measure.

42. The method of claim 39 in which the countermeasure that modifies the security breach entity or influences the output of that entity is a mitigative measure.

43. The method of claim 39 in which the countermeasure that modifies the disruption entity or influences the output of that entity is an alleviative measure.

44. The method of claim 28 in which the system is a computer.

45. The method of claim 28 in which the system is a computer network.

46. The method of claim 28 in which the system is a telecommunication system.

47. The method of claim 28 in which the system is a mobile communications device or personal digital assistant.

48. The method of claim 28 in which the system is a building, group of buildings, physical infrastructure, means of transport or a transport infrastructure, aircraft or vehicle.

49. The method of claim 28 in which the system is a physical storage container.

50. The method of claim 28 in which the system is a business, business process or business system.

51. The method of claim 28 in which an entity in the risk chain describes a population of one or more people who seek or otherwise obtain unauthorised access to the target system or who seek to or otherwise influence it in an unauthorised manner.

52. The method of claim 28 in which an entity in the risk chain describes a population of one or more computer viruses or worms or Trojan Horses or computers.

53. The method of claim 52 in which a parameter is the age of the virus.

54. The method of claim 28 in which an entity in the risk chain describes a population of one or more fires, floods, earthquakes or other physical acts which have an impact on the target system.

55-64. (canceled)
